(19) United States
(12) Patent Application Publication
(10) Pub. No.: US 2024/0266993 A1
(43) Pub. Date: Aug. 8, 2024

(54) VARIABLE TERRAIN SOLAR TRACKER

(71) Applicant: NEVADOS ENGINEERING, INC., Oakland, CA (US)

(72) Inventors: Yezin TAHA, San Francisco, CA (US); Amitoj Gill, Roseville, CA (US); Laura Sverchek, San Francisco, CA (US)

(73) Assignee: NEVADOS ENGINEERING, INC., Oakland, CA (US)

(21) Appl. No.: 18/433,077

(22) Filed: Feb. 5, 2024

Related U.S. Application Data
(60) Provisional application No. 63/443,620, filed on Feb. 6, 2023.

(51) Int. Cl. H02S 20/32

(52) U.S. Cl. CPC H02S 20/32

(57) ABSTRACT

Solar module clips that may be advantageously employed in solar trackers to decrease time and effort in the installation and the alignment of solar modules—which are important for the subsequent efficiency of solar modules in operation—as well as ensure proper alignment of solar modules and/or solar module frames.

### CROSS REFERENCE TO RELATED APPLICATIONS

This application claims benefit of priority to U.S. provisional application No. 63/443,620 titled “VARIABLE TERRAIN SOLAR TRACKER” filed on Feb. 6, 2023, which is incorporated by reference in this application in its entirety.

### FIELD OF THE INVENTION

The invention relates generally to solar trackers and solar module clips used in the solar trackers.

### BACKGROUND

Two types of mounting systems are widely used for mounting solar panels. Fixed tilt mounting structures support solar panels in a fixed position. The efficiency with which panels supported in this manner generate electricity can vary significantly during the course of a day, as the sun moves across the sky and illuminates the fixed panels more or less effectively. However, fixed tilt solar panel mounting structures may be mechanically simple and inexpensive, and in ground-mounted installations may be arranged relatively easily on sloped and/or uneven terrain.

Single axis tracker solar panel mounting structures allow rotation of the panels about an axis to track the motion of the sun across the sky. For example, a single axis tracker may be arranged with its rotation axis oriented generally North-South, so that rotation of the panels around the axis can track the East-West component of the sun's daily motion. Alternatively, a single axis tracker may be arranged with its rotation axis oriented generally East-West, so that rotation of the panels around the axis can track the North-South component of the sun's daily (and seasonal) motion. Solar panels supported by single axis trackers can generate significantly more power than comparable panels arranged in a fixed position.

Installing multiple solar panels in a large array can be a time consuming process complicated by the difficulty of aligning each solar panel for optimum efficiency, as well as the manufacturing capabilities needed to produce solar panel securing devices that can accommodate all of the various dimensions and orientations of solar panels. Conventional single-axis trackers often comprise long lengths of steel that must be connected to form the strongback that the solar modules are mounted on. After the torque tubes are aligned, the solar panels must be mounted on top of them. A conventional solar module clip has its length in the East-West direction, with a North face, a South face, and a top face connecting the North and South face. The North and South face would be the same size, and the top face would be completely flat, without any markers that serve to aid alignment on the torque tube. Because they lack any alignment aids, it is a difficult and time consuming process to manually align a solar panel on a conventional solar module clip in the East-West direction. If a solar panel module is installed in a skewed fashion, power losses or worse may result from the misalignment.

Consequently, there is a need for an improved solar panel module mounting clip that can properly secure and accommodate solar panel modules of differing dimensions in an efficient way that reduces the time and cost of installation, as well as ensures proper alignment of the modules without requiring alignment jigs.

### SUMMARY

Solar module clips presented in this disclosure may advantageously allow simplified installation and alignment of solar panels. They provide secure retaining of the solar modules in addition to their alignment capabilities. These advantages may be achieved by, for example, clamps with wedge-shaped features on the rail of the module clip that allow easy installation of the module frames, as well as tube straps with hooks that allow easy alignment and/or attachment to the rail.

These and other embodiments, features and advantages of the present invention will become more apparent to those skilled in the art when taken with reference to the following more detailed description of the invention in conjunction with the accompanying drawings that are first briefly described.

### BRIEF DESCRIPTION OF THE DRAWINGS

FIG. 1 shows an all-terrain solar tracker with angle changes along its length to follow the natural terrain.

FIG. 2 shows a solar module clip with clamps having wedge-shaped features on a rail and hooks on the tube strap secured to the rail.

FIGS. 3A-3C shows different views of a solar module clip secured to a torque tube. FIG. 3A shows a perspective view, FIG. 3B shows a cross section viewed looking down the length of the torque tube, and FIG. 3C shows a side view.

FIGS. 4A-4C shows different views of a solar module frame secured to a solar module clip on a torque tube. FIG. 4A shows a perspective view from a first angle, FIG. 4B shows a perspective view from a second angle, and FIG. 4C shows a side view.

### DETAILED DESCRIPTION

The following detailed description should be read with reference to the drawings, in which identical reference numbers refer to like elements throughout the different figures. The drawings, which are not necessarily to scale, depict selective embodiments and are not intended to limit the scope of the invention. The detailed description illustrates by way of example, not by way of limitation, the principles of the invention. This description will clearly enable one skilled in the art to make and use the invention, and describes several embodiments, adaptations, variations, alternatives and uses of the invention.

As used in this specification and the appended claims, the singular forms “a,” “an,” and “the” include plural referents unless the context clearly indicates otherwise. Also, the term “parallel” is intended to mean “substantially parallel” and to encompass minor deviations from parallel geometries. The term “vertical” refers to a direction parallel to the force of the earth's gravity. The term “horizontal” refers to a direction perpendicular to “vertical”.

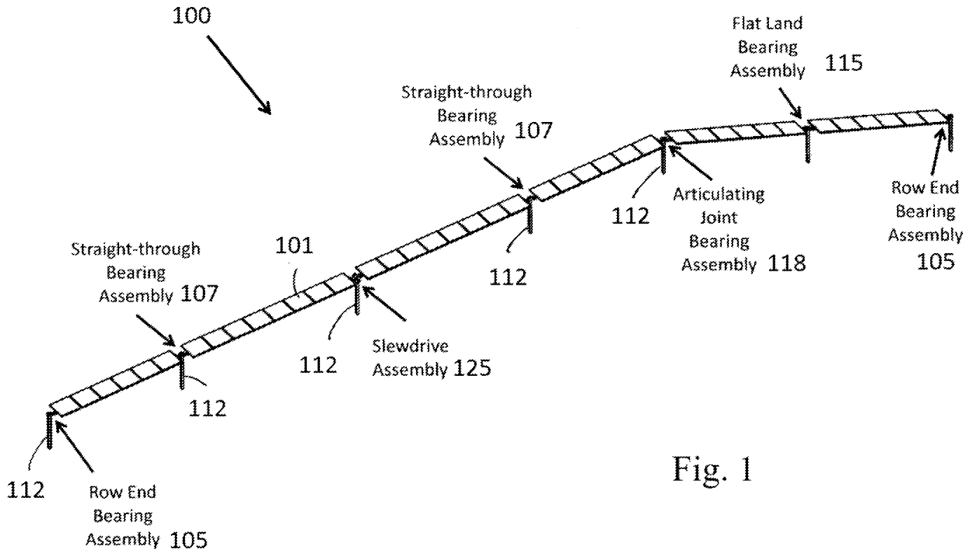

FIG. 1 shows an example all-terrain solar tracker arranged on varying terrain with angle changes along its length to follow the natural terrain. This tracker employs examples of many of the components that may or may not be present in a tracker. These components include articulated bearings supporting significant changes in angular orientation between adjacent segments of the torque tube, flexure bearings supporting smaller changes in angular orientation between adjacent segments of the torque tube without requiring an articulated bearing, straight through bearings, mechanical stops limiting rotation of the tracker, and a row end bearing. The tracker in addition includes a slew drive configured to drive rotation of the torque tube around its long axes. Although the example of FIG. 1 and other figures shows a particular arrangement of certain components, other variations may employ any suitable combination and arrangement of the components described in this disclosure. Some elements illustrated in certain figures may be unlabeled in those figures and only be labelled in other figures, for convenience and clarity of illustration and to avoid repetition.

FIG. 1 illustrates an example variable terrain and single axis solar tracker 100, which employs support posts 112, solar panel module supports such as torque tubes 104 extending between the support posts, and solar panel modules 101 supported by the torque tubes. Multiple solar panel modules may be between each of the support posts, and they may all be of a same size as one another, or some of them may be different sizes from each other. The solar panel modules may each comprise a solar module frame which supports the solar cells in the panels. The number of solar panel modules between each of the support posts may be the same along the tracker, or it may vary depending on the terrain and the spacing of specific support posts.

This example variable terrain solar tracker is arranged on uneven terrain and includes two rotation axes: a first rotation axis arranged along a slope, and a second horizontal rotation axis along a flat portion of land above the slope. The angle between the first rotation axis and the second horizontal rotation axis may be, for example, ≥0 degrees, ≥5 degrees, ≥10 degrees, ≥15 degrees, ≥20 degrees, ≥25 degrees, ≥30 degrees, ≥35 degrees, ≥40 degrees, ≥45 degrees, ≥50 degrees, ≥55 degrees, ≥60 degrees, ≥65 degrees, ≥70 degrees, ≥75 degrees, ≥80 degrees, ≥85 degrees, or up to 90 degrees. These examples refer to the magnitude of the angle between the first rotation axis and the second horizontal axis. The angles may be positive or negative.

Various types of assemblies may be disposed on top of support posts, depending on the terrain and the position of the support post with relation to the rest of the trackers: straight-through bearing assemblies 107 for sloping planar surfaces, flat land bearing assembly 115 for flat land, row end bearing assembly 105 for an end of a the tracker, articulating joint bearing 118 assembly for changing terrain angles, and slew drive assembly 125 at an end of the tracker or an intermediate position along the tracker in order to drive rotation of the tracker.

For example, opposite ends of the tracker are rotationally supported by row end bearing assemblies 105 on support posts 112. The portion of the tracker arranged on the slope is supported by straight-through bearing assemblies 107, which include thrust bearings that isolate and transmit portions of the slope load to corresponding support posts 112. The portion of the tracker arranged on flat land, above the slope, is rotationally supported by a flat land bearing assembly 115 which may be a conventional pass-through bearing assembly lacking thrust bearings as described above. The slew drive assembly may drive rotation of the solar panel modules 101 about the first and second rotation axes to track the sun. The solar panel modules 101 may be supported on torque tubes that are parallel with and optionally displaced (e.g., displaced downward) from the rotation axis of the slew drives. The torque tubes may also be aligned with rather than displaced from the rotation axis of the slew drives. Articulating joint bearing assembly 118 links the two non-collinear rotation axes and transmits torque between them. Example configurations for bearing assemblies 105, 107 and 118 are described in more detail below.

Other variations of the variable terrain solar tracker 100 may include other combinations of bearing assemblies 105, 107, 115, and 118 arranged to accommodate one, two, or more linked rotational axes arranged along terrain exhibiting one or more sloped portions and optionally one or more horizontal (flat) portions. Two or more such trackers may be arranged, for example next to each other in rows, to efficiently fill a parcel of sloped and/or uneven terrain with electricity-generating single axis tracking solar panels.

As noted above articulating joint bearing assembly 118 accommodates a change in direction of the rotational axis along the tracker. As used herein, “articulating joint” refers to a joint that can receive torque on one axis of rotation and transmit the torque to a second axis of rotation that has a coincident point with the first axis of rotation. This joint can be inserted between two spinning rods that are transmitting torque to allow the second spinning rod to bend away from the first spinning rod without requiring the first or second spinning rod to flex along its length. One joint of this type, which may be used in articulating joint bearing assemblies as described herein, is called a Hooke Joint and is characterized by having a forked yoke that attaches to the first spinning rod, a forked yoke attached to the second spinning rod, and a four-pointed cross between them that allows torque to be transmitted from the yoke ears from the first shaft into the yoke cars of the second shaft.

A solar panel array control system electrically connected to the tracker may be provided, which may control operation of one or more solar panels in the solar array. Operation of the one or more solar panels may include positioning of the one or more solar panels. For example, the solar panel array control system may control an orientation of one or more solar panels. The control system may send signals to a solar panel supporting structure, which may affect the position of the one or more solar panels. The articulating joint may be capable of allowing a position of a solar panel to be controlled from the control system. The solar panel support structure affecting position of the one or more solar panels may include a slew drive and a controller directing the slew drive.

In these trackers the solar panel modules need to be attached to the torque tube in a secure fashion in order to ensure proper and precise operation of the tracker. Misalignment of the modules on installation can result in power losses or other malfunctions. The installation of these solar modules can be time consuming. In embodiments of the invention, module clips simplifying installation and alignment of the solar modules are described below.

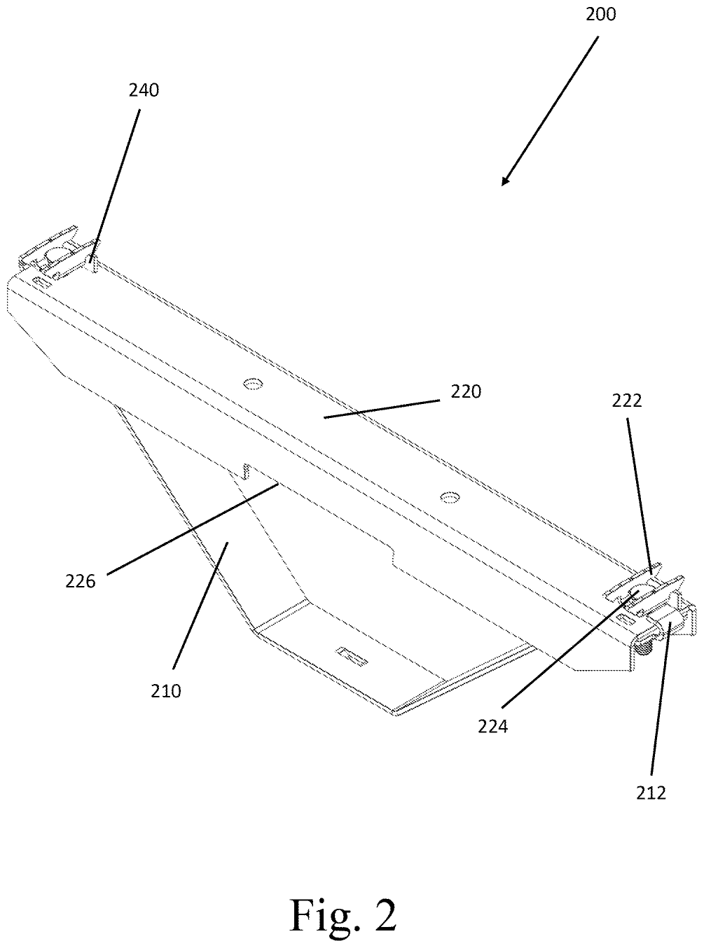

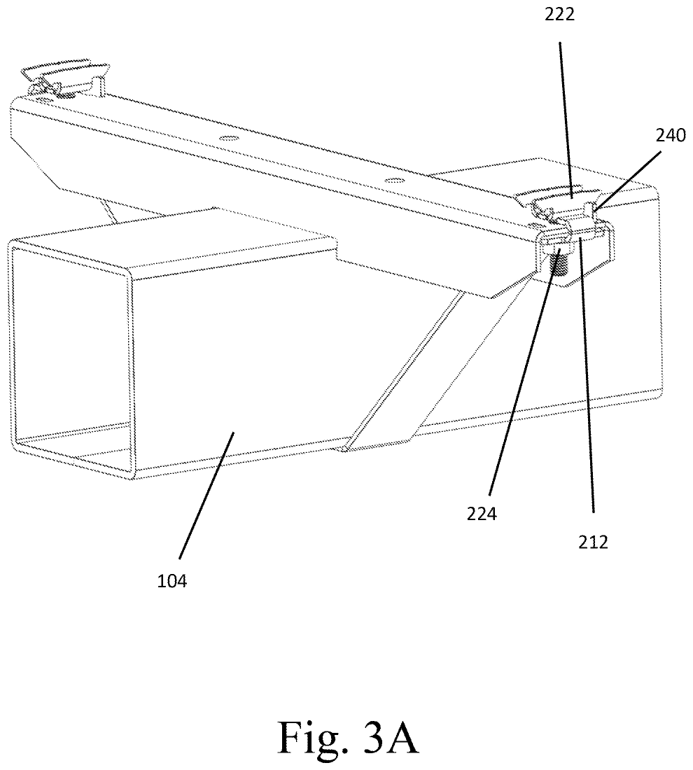

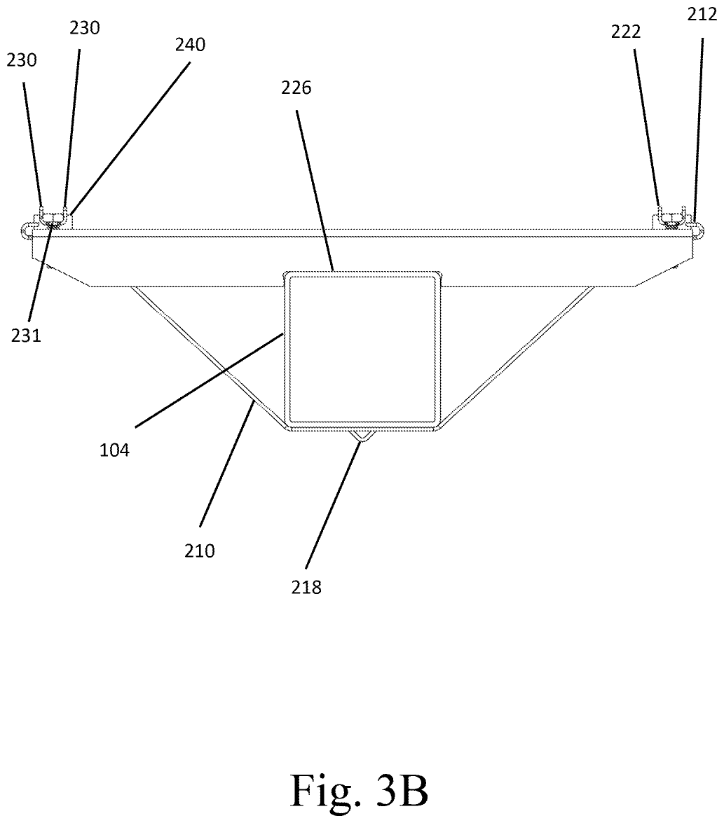

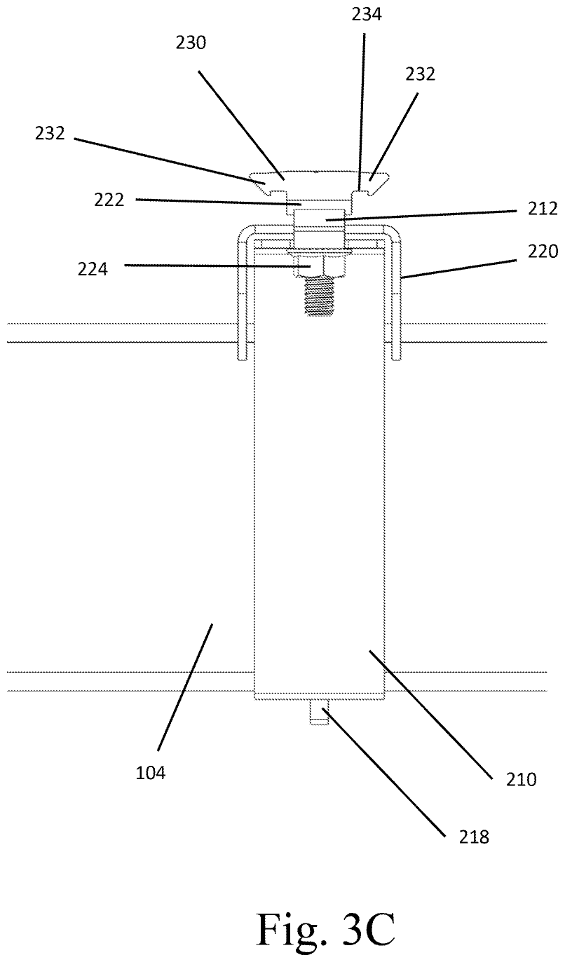

In embodiments of the invention, FIG. 2 illustrates a module clip 200 by itself without being attached to any other device or component. The module clip is designed to secure a solar module frame 120 to a torque tube 104. Broadly speaking, the module clip includes a rail 220 and a tube strap 210 attached to the rail. The tube strap secures the rail to the torque tube, as shown in FIGS. 3A-3C in perspective, cross section, and side views, respectively. The cutout 226 is shaped to fit over a top and part of two side surfaces of the torque tube (which is rectangular and/or square as an example), while a bottom part of the tube strap is flush against the bottom of the torque tube. That is, the cutout of the rail may have a same or similar width with the top of the torque tube, while the bottom part of the tube strap may have a same or similar with the bottom of the torque tube (which may also the same width as the top of the torque tube). The cutout is rectilinear as an example, though it may have any shape designed to fit over a torque tube, such as curvilinear when the torque tube is round in cross section.

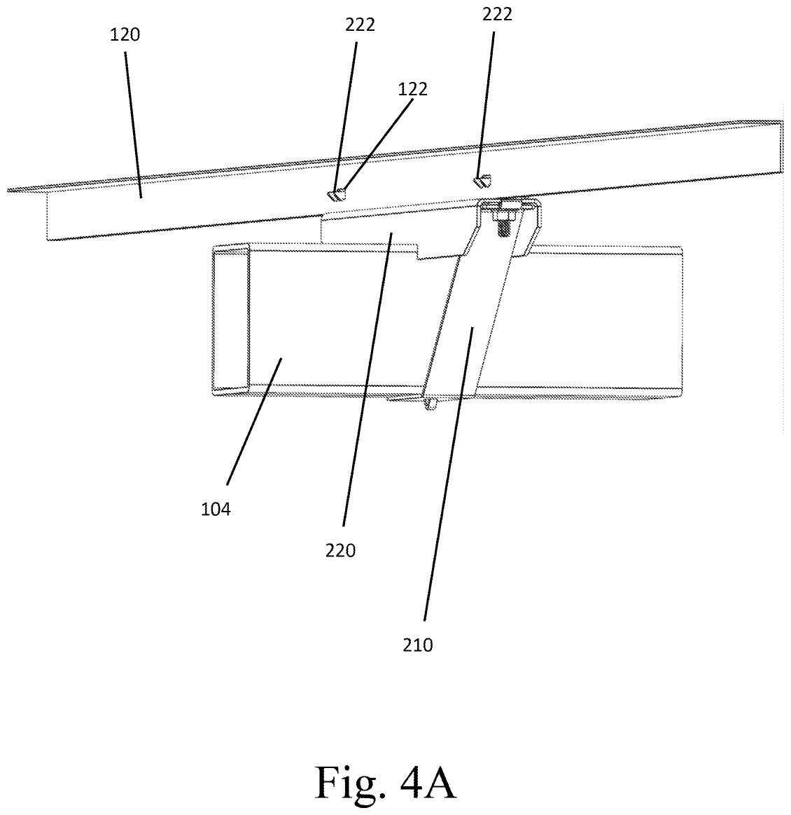

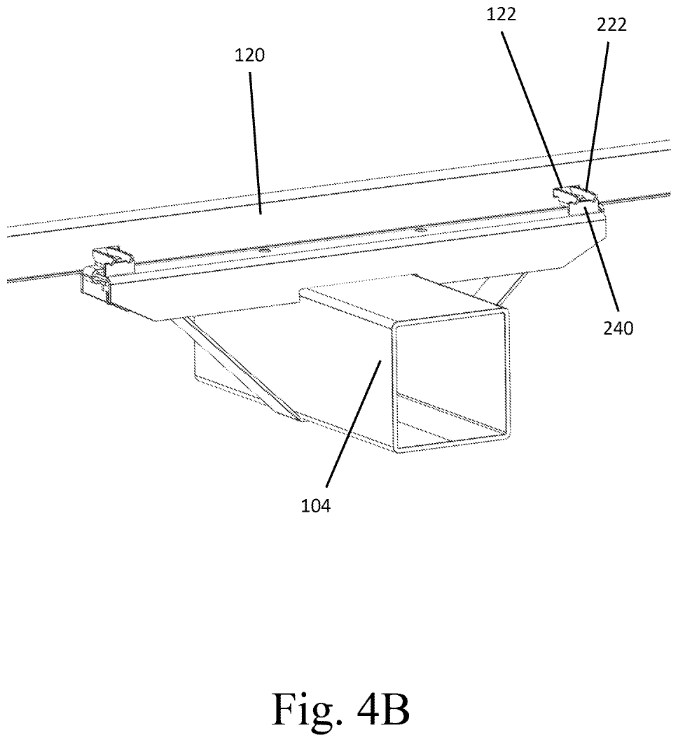

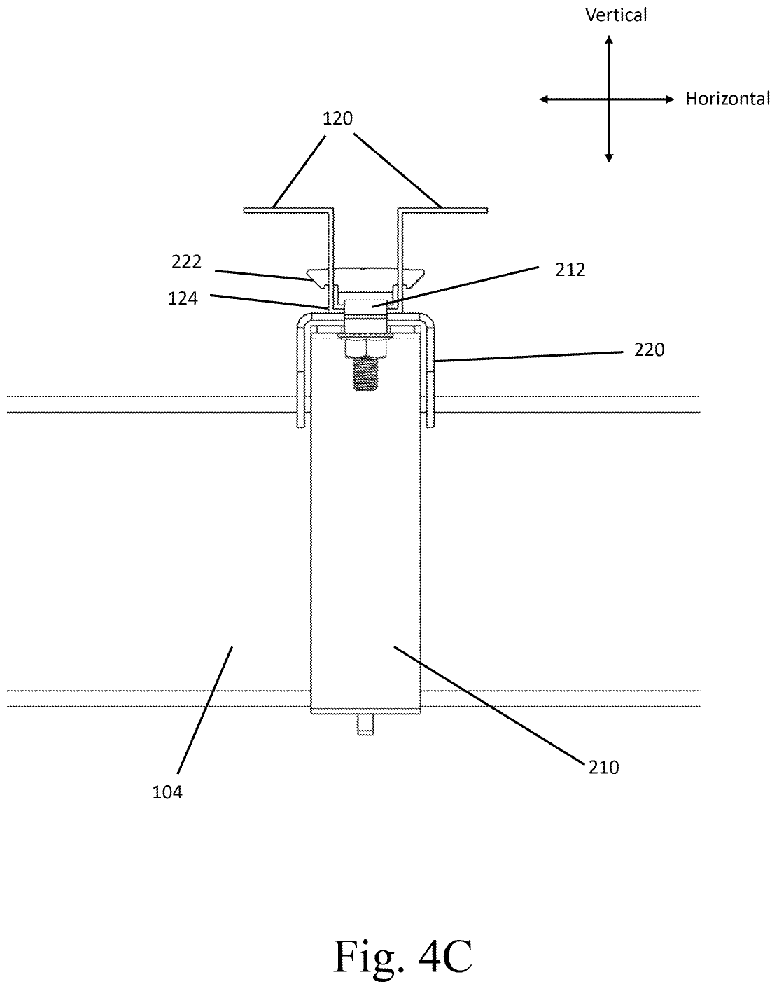

The module clip 200 includes features to secure the solar module frame 120 to the module clip, such as clamps 222. These clamps 222 have the capability to clamp down on the sides of holes 122 in the solar module frame and thus secure the solar module frame to the module clip, as shown in FIGS. 4A-4C in perspective, cross section, and side views, respectively. The clamps may each include at least one wing 230. The figures show each clamp including a pair of wings 230 connected together by a bridge 231 which is bolted to the rail 220 by a bolt 224. In turn, the wings 230 may each include a pair of wedge-shaped features 232 disposed on opposite sides of each other, and trenches 234 adjacent to each of the wedge-shaped features. The wedge-shaped features may be shaped exactly or similarly to triangles, but are not so limited. A solar module frame may be installed to the module clip by sliding the wedge-shaped features into the hole of the solar module frame. Because of the wedge shape, the wedge-shaped feature may easily slide into the hole of the solar module frame as it is brought closer to the wing, since the edges of the hole push up against the clamp as it is slid. The upper vertex of the wedge-shaped feature is vertically higher than the bottom vertex (forming part of the trench 234). A side of the wedge-shaped feature may extend from the upper vertex of the wedge-shaped feature downward to the bottom vertex, for example at 30-60 degrees, for example at 45 degrees. Eventually the solar module frame will slide into the trench, where it will be constrained by a side of the wedge-shaped feature from moving out and will thus be secured. At this point the bolts may be loosely installed, so the clamp may lift as it is slid into the hole of the solar module frame, then rest onto the hole of the solar module frame as it slides into the trench. Once the hole is in the trench the bolt may be torqued down so that the clamp clamps down onto the solar module frame. A side view in FIG. 4C shows the installed solar module frame. As a result, installation of the solar module frame to the module clip may advantageously be simplified. It should be noted that the vertical height of the clamp, when calculated from the top of the rail to the top of the clamp, is lower than the vertical height of the solar module frame calculated from the top of the rail to the top of the solar module frame. This is because the clamp may clamp to a hole on a lower part of the solar module frame, and does not need to extend over the solar module frame to clamp to the top of the solar module frame.

Each clamp 222 may include two wings 230 each including two wedge-shaped features 232, which means each clamp may include two wedge-shaped features on the same side as each other (and two wedge-shaped features on the opposite side from the first two, so that the clamp is symmetrical about a vertical line). Each rail 220 may, in turn, include two clamps disposed on opposite sides of the rail as each other, resulting in a total of four wedge-shaped features facing the same side. These two clamps may be disposed adjacent to edges of the rail, and may be spaced apart at a distance from, for example, 300-1200 millimeters, such as 400-500 millimeters. As a result, during installation four wedge-shaped features may be simultaneously slid into two holes of the solar module frame, as shown in FIG. 4A. The two-wedge-shaped features of a single clamp may share a same hole of the solar module frame. Of course, the quantities of such elements may not be so limited, and each clamp may include less or more wings (such as one or three), and each rail may include less or more clamps (such as one or three).

The wedge-shaped features 232 of the clamps 222 may be disposed on opposite sides of each other, as shown in FIG. 3C. In a solar tracker, the module clip 200 may be placed at an end of the tracker. In this case, the module clip secures a solar module frame 120 on one end, while the other end does not secure any solar module frame. Since this might lead to an imbalance of forces, a standoff 240 may be placed on the side of each of the clamps which does not secure a solar module frame. This standoff is a removable piece that may be secured to the module clip by the clamp, which clamps down on a top of the standoff which is placed on the rail 220. When the standoff is placed on one side of the clamp, it prevents the clamp from tilting due to having the solar module frame on one side and not the other. As can be seen in FIG. 4B, the standoff may be a significantly smaller piece of material compared to the solar module frame and the rail, being lower in height, width, and length to both. Additionally, two standoffs may be used for every rail, one for each clamp, rather than a continuous piece of material; however, this is not required, and a continuous piece of material may be used as a standoff to balance multiple clamps on a single rail.

The clamps 222 may be bolted to the rail 220 by the bolts 224, and they may also be simultaneously secured to the tube strap 210 with the same bolts. That is, the tube straps may be secured to the rail at the same locations that the clamps are secured to the rails. The regions in which the tube strap is bolted to the rail may be those regions immediately adjacent to the hooks 212. The shape of the tube strap may flare out from the bottom of the torque tube 104 rather than sticking flush to the sides of the torque tube. That is, the tube strap may have or include a trapezoidal cross section when viewed along the length of the torque tube upon which it is installed, and the trapezoid may be an isosceles trapezoid (e.g., the bottom of the tube strap may have regions extending out from it at an angle of 30-60 degrees, for example 45 degrees). However, the tube strap is not so limited and the tube strap may have any shape as a cross section, such as semicircular. The bottom of the tube strap may have a length similar or the same as a length of the cutout 226 on the rail. The bottom of the tube strap may be flat so it lays flush against a rectangular torque tube, or curved so it follows the contours of a circular torque tube. The bottom of the tube strap may include a cable management hole 218 (visible in, for example, FIG. 3B) which allows easy bundling of cables in the solar tracker. The cable management hole may have a triangular or triangular-like cross section, although it is not so limited, and may have a semi-circular or rectangular cross-section.

The ends of the tube strap may include hooks 212 on opposite sides from each other. The hooks may extend past a length of the rail 220 (e.g., the longest dimension and/or longest horizontal dimension of the rail) so that the tube strap 210 has a longer length than the rail, then curve back in past the ends of the rail so that the ends of the hooks are disposed over the rail, as shown in FIG. 3B. In other words, the hooks may each be disposed both under and over one end/edge of the rail, so that each hook at partially surrounds an end/edge of the rail. These hooks allow easy installation of the tube strap onto the rail 220 and torque tube 104. When the rail is first sitting on the torque tube as the module clip is installed, the tube strap may be brought under the torque tube and clipped onto and/or hanging off the rail via the hooks. This allows easy alignment of the tube strap to the rail so the tube strap stays in place as the bolts are installed. The tube strap may be clipped via the hooks onto the rail without bolts 224 so that the module clip 200 is at least temporarily secured to the torque tube without the need for bolts. Once the the bolts are tightened, the hooks themselves may not be in direct contact with the rail, as shown in FIG. 3B. When that happens, the hook may be in direct contact with the rail, for example one or both of the top side of the top surface of the rail and the bottom side of the top surface of the rail. In either case, installation of the module clip 200 onto the torque tube is advantageously simplified.

The hooks 212 may also provide a hard stop for the solar module frame 120 to prevent skewing of the installed solar module frame on the module clip 200, for example constraining the movement of the solar module frame along the torque tube axis. FIG. 4C shows how the hooks, after being bolted to the rail 220, constrain the solar module frames installed on either side of the module clip from moving in at least one direction along which the torque tube 104 extends. The feet 124 of the solar module frames may directly contact the hook. Pillars of the solar module frame extending upwards from the feet 124 may not directly contact the hook. The pillars may also not directly contact the wings 230, except at the holes 122. Alternatively, the pillars may directly contact the wedge-shaped feature 232 at a side of the wedge-shaped feature that forms the trench 234, so that the wedge-shaped feature and the hook constrain the solar module frame on two opposing sides. In any case, since the hooks are placed on opposing sides of the module clip and act as hard stops on both sides of the module clip, they may prevent the solar module frame from being installed in a skewed fashion. In embodiments of the invention, the hooks may not be in direct contact with the clamps 222, although this is not a requirement. If a standoff 240 is used with a module clip, it may not be in direct contact with the hooks, although this is not a requirement. When the hooks act as a hard stop, they may have a smaller width compared to the smallest dimension of the clamp which is parallel to the width of the hook (extending parallel to the direction of the torque tube.

The rail 220 may have a top surface upon which the clamp 222 and/or the solar module frame 120 may be disposed. From the top surface may extend one or two side surfaces, each of which contain the cutout 226 to fit over the torque tube. The side surfaces may extend perpendicularly from the top surface. The tube strap 210 may have a smaller width than the width of the rail, so that the tube strap fits between the side surfaces of the rail. The widths may be perpendicular to the length and/or may extend parallel to a direction of the torque tube 104 when the module clip 200 is installed on the torque tube.

This disclosure is illustrative and not limiting. Further modifications will be apparent to one skilled in the art in light of this disclosure and are intended to fall within the scope of the appended claims.

What is claimed is:

1. A solar module securing device, comprising:
a rail comprising a first edge and a second edge opposite from the first edge,
a plurality of clamps disposed on the rail and each comprising a plurality of wedge-shaped features, and
a tube strap secured to the rail and comprising at least one hook disposed over the first edge.

2. The solar module securing device of claim 1, wherein the clamps disposed on rail comprise a first clamp adjacent to the first edge and a second clamp adjacent to the second edge.

3. The solar module securing device of claim 1, wherein the clamps each comprise a trench adjacent to each of the wedge-shaped features.

4. The solar module securing device of claim 1, wherein the clamps each comprise at least one wing, each wing comprising a pair of the wedge-shaped features disposed on opposite sides from each other.

5. The solar module securing device of claim 4, wherein the at least two wings comprise two wings extending parallel with each other.

6. The solar module securing device of claim 5, further comprising a bridge coupling the two wings to each other.

7. The solar module securing device of claim 1, wherein the rail comprises a top surface and a first side surface and a second side surface each extending from the top surface, the first side surface and the second side surface each comprising a cutout.

8. The solar module securing device of claim 1, wherein the cutout is rectilinear.

9. The solar module securing device of claim 1, wherein the rail comprises a plurality of bolt holes.

10. The solar module securing device of claim 9, wherein the clamps are secured to the rail by bolts disposed through the bolt holes.

11. The solar module securing device of claim 10, wherein the tube strap is secured to the rail by the bolts.

12. The solar module securing device of claim 1, wherein the tube strap comprises a cable management hole.

13. The solar module securing device of claim 1, wherein at least part of the tube strap has a cross section comprising a trapezoidal shape.

14. The solar module securing device of claim 1, wherein the at least one hook is disposed below the first edge of the rail.

15. The solar module securing device of claim 1, wherein the at least one hook comprises a first hook disposed above the first edge and a second hook disposed above the second edge.

16. The solar module securing device of claim 15, wherein the first and second hook are disposed on outermost edges of the tube strap.

17. The solar module securing device of claim 1, wherein the tube strap has a greater length than the rail.

18. The solar module securing device of claim 1, wherein the tube strap comprises a lowest portion extending parallel to a topmost surface of the rail.

19. A solar module securing device, comprising:
a rail comprising a first edge and a second edge opposite from the first edge,
a first clamp disposed on the rail and adjacent to the first edge of the rail and a second clamp disposed on the rail and adjacent to the second edge of the rail, the first and second clamp each comprising a plurality of wedge-shaped features, and
a tube strap secured to the rail and having a greater length than the rail, comprising a first hook at a first edge of the tube strap and a second hook at a second edge of the tube strap, the first hook disposed above the first edge of the rail and the second hook disposed above the second edge of the rail.

20. A solar panel module tracker, comprising:
a solar panel module comprising mounting holes,
a torque tube below the solar panel module,
a solar module clip secured to the torque tube, comprising:
a rail,
at least one clamp disposed on the rail comprising at least one wedge-shaped feature, and
a tube strap below the rail comprising at least one hook.
